(19) United States
(12) Patent Application Publication
(10) Pub. No.: US 2015/0131027 A1
(43) Pub. Date: May 14, 2015

(54) BACKLIGHT MODULE AND DISPLAY APPARATUS THEREOF

(71) Applicant: Wistron Corporation, New Taipei City (TW)

(72) Inventors: Hua-Ning Qiao, New Taipei City (TW); Chao Zhou, New Taipei City (TW)

(73) Assignee: Wistron Corporation, New Taipei City (TW)

(21) Appl. No.: 14/251,660

(22) Filed: Apr. 14, 2014

(30) Foreign Application Priority Data
Nov. 12, 2013 (CN) 201310561770.9

(51) Int. Cl. F21V 8/00

(52) U.S. Cl. CPC G02B 6/0088
USPC 349/65; 362/612

(57) ABSTRACT

A backlight module includes a light guide plate, alight emitting diode, a limiting block, an elastic member, and a bezel having a containing structure. The light guide plate is disposed in the containing structure and has a side surface and a light entrance surface opposite to the side surface. The light emitting diode is disposed at a position corresponding to the light entrance surface of the light guide plate for emitting light into the light guide plate via the light entrance surface. The limiting block is located at a side of the light emitting diode and extends inwardly from the containing structure for abutting against the light entrance surface. The elastic member abuts against at least one of the light entrance surface and the side surface and the containing structure and is used for providing elastic force to drive the light guide plate to abut against the limiting block.

### BACKGROUND OF THE INVENTION

1. Field of the Invention

The present invention relate to a backlight module and a display apparatus thereof, and more specifically, to a backlight module utilizing a limiting block and an elastic member to position a light guide plate and a display apparatus thereof.

2. Description of the Prior Art

Since liquid crystal molecules do not produce light themselves, a conventional method for driving a liquid crystal display device to display images involves utilizing a backlight module to provide light with sufficient brightness and uniform distribution to the liquid crystal display device. Therefore, a backlight module is one of the major components of the liquid crystal display device. The related light emitting design is to fix a light guide plate to a bezel by glue and then utilize a light emitting diode disposed at a light entrance side of the light guide plate to emit light into the light guide plate. Accordingly, the backlight module could generate a surface light source with sufficient brightness and uniform distribution via the light guide design of the light guide plate.

However, in practical application, expansion or shrink of the light guide plate occurs in different environment temperatures. On this condition, if the adhesive strength of the glue is insufficient, movement of the light guide plate on the bezel may occur to change the optical coupling distance between the light emitting diode and the light guide plate, so as to cause the problem that only a part of light emitted from the light emitting diode could be incident into the light guide plate as well as cause the light leakage problem. Thus, it may greatly reduce efficiency of the backlight module in use of light. Furthermore, although the aforesaid problems could be solved by utilizing glue with a strong adhesive strength to prevent movement of the light guide plate on the bezel, this method may further cause a difficult rework process for the backlight module.

### SUMMARY OF THE INVENTION

An objective of the present invention is to provide a backlight module utilizing a limiting block and an elastic member to position a light guide plate and a display apparatus thereof, to solve the aforesaid problem.

The present invention provides a backlight module including a bezel, a light guide plate, at least one light emitting diode, a limiting block, and an elastic member. The bezel has a containing structure. The light guide plate is disposed in the containing structure of the bezel and has a side surface and a light entrance surface opposite to the side surface. The at least one light emitting diode is disposed at a position corresponding to the light entrance surface of the light guide plate. The at least one light emitting diode is for emitting light into the light guide plate via the light entrance surface. The limiting block is located at a side of the at least one light emitting diode and extends inwardly from the containing structure for abutting against the light entrance surface of the light guide plate. The elastic member abuts against at least one of the light entrance surface and the side surface of the light guide plate and the containing structure. The elastic member is for providing elastic force to drive the light entrance surface of the light guide plate to abut against the limiting block, so as to position the light guide plate cooperatively with the limiting block.

According to the claimed invention, the elastic member is an elastic strip abutting against the side surface of the light guide plate and the containing structure in a compressed state.

According to the claimed invention, a plurality of through holes is formed on the elastic strip.

According to the claimed invention, the elastic strip is made of rubber, silica gel, or foam material.

According to the claimed invention, the elastic member is a spring. The spring is connected to the side surface of the light guide plate and the containing structure in a compressed state or is connected to the light entrance surface of the light guide plate and the containing structure in a stretched state.

According to the claimed invention, the elastic member includes an elastic strip and a spring. The elastic strip abuts against the side surface of the light guide plate and the containing structure in a compressed state. The spring is connected to the side surface of the light guide plate and the containing structure in a compressed state or connected to the light entrance surface of the light guide plate and the containing structure in a stretched state.

The present invention further provides a display apparatus including a liquid crystal panel and a backlight module. The backlight module is disposed under the liquid crystal panel for emitting light to the liquid crystal panel. The backlight module includes a bezel, a light guide plate, at least one light emitting diode, a limiting block, and an elastic member. The bezel has a containing structure. The light guide plate is disposed in the containing structure of the bezel and has a side surface and a light entrance surface opposite to the side surface. The at least one light emitting diode is disposed at a position corresponding to the light entrance surface of the light guide plate. The at least one light emitting diode is for emitting light into the light guide plate via the light entrance surface. The limiting block is located at a side of the at least one light emitting diode and extends inwardly from the containing structure for abutting against the light entrance surface of the light guide plate. The elastic member abuts against at least one of the light entrance surface and the side surface of the light guide plate and the containing structure. The elastic member is for providing elastic force to drive the light entrance surface of the light guide plate to abut against the limiting block, so as to position the light guide plate cooperatively with the limiting block.

In summary, the present invention utilizes the elastic force of the elastic member to drive the light guide plate for abutting against the limiting block. Accordingly, even if expansion of the light guide plate occurs in a hot environment or shrink of the light guide plate occurs in a cold environment, the backlight module of the present invention could still make the optical coupling distance between the light guide plate and the light emitting diode remain constant. In such a manner, the present invention could effectively solve the prior art problem that only a part of light emitted from the light emitting diode could be incident into the light guide plate and the light leakage problem, so as to improve efficiency of the backlight module in use of light. Furthermore, since the backlight module of the present invention could only utilize the limiting block and the elastic member to position the light guide plate without glue, the present invention could further simplify the rework process of the backlight module.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a display apparatus according to an embodiment of the present invention.

FIG. 2 is a partial sectional diagram of the display apparatus in FIG. 1 along a sectional line A-A.

FIG. 3 is an exploded diagram of a backlight module in FIG. 2.

FIG. 4 is a partial enlarged diagram of a bezel in FIG. 3.

FIG. 5 is a partial sectional diagram of a display apparatus according to another embodiment of the present invention.

### DETAILED DESCRIPTION

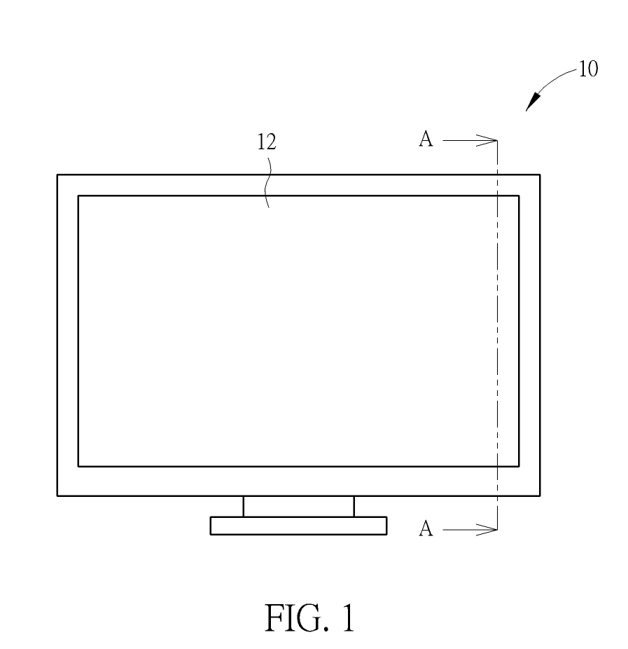

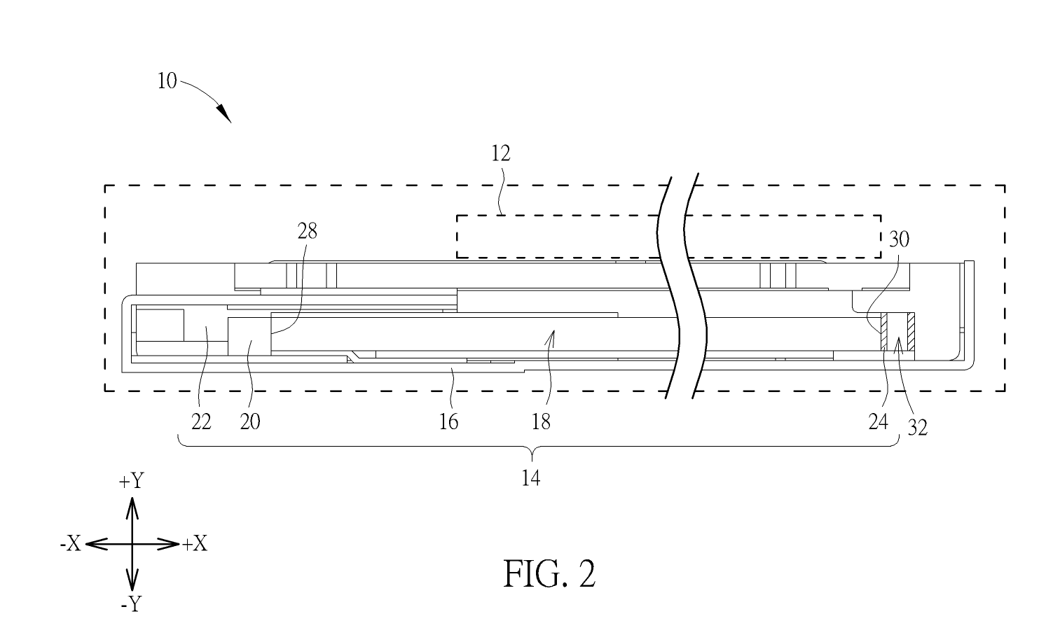

Please refer to FIG. 1 and FIG. 2. FIG. 1 is a diagram of a display apparatus 10 according to an embodiment of the present invention. FIG. 2 is a partial sectional diagram of the display apparatus 10 in FIG. 1 along a sectional line A-A. In this embodiment, the display apparatus 10 could be a liquid crystal television (as shown in FIG. 1), but not limited thereto, meaning that the display apparatus 10 could also be other conventional display device (e.g. a liquid crystal screen of a notebook). As shown in FIG. 1 and FIG. 2, the display apparatus 10 includes a liquid crystal panel 12 and a backlight module 14. For clearly showing the design of the backlight module 14, the liquid crystal panel 12 and the other related components (e.g. a side frame) of the display apparatus 10 besides the liquid crystal panel 12 and the backlight module 14 are briefly depicted by dashed lines in FIG. 2. The backlight module 14 is disposed under the liquid crystal panel 12 for providing light with sufficient brightness and uniform distribution to the liquid crystal panel 12.

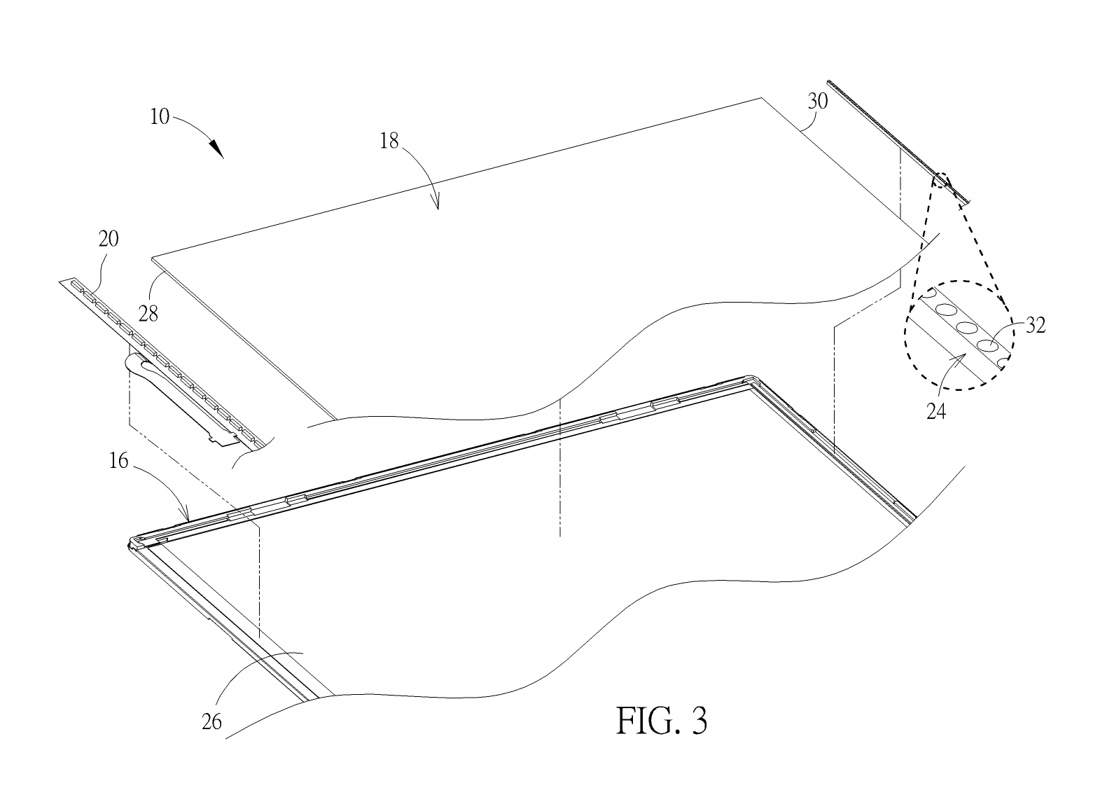

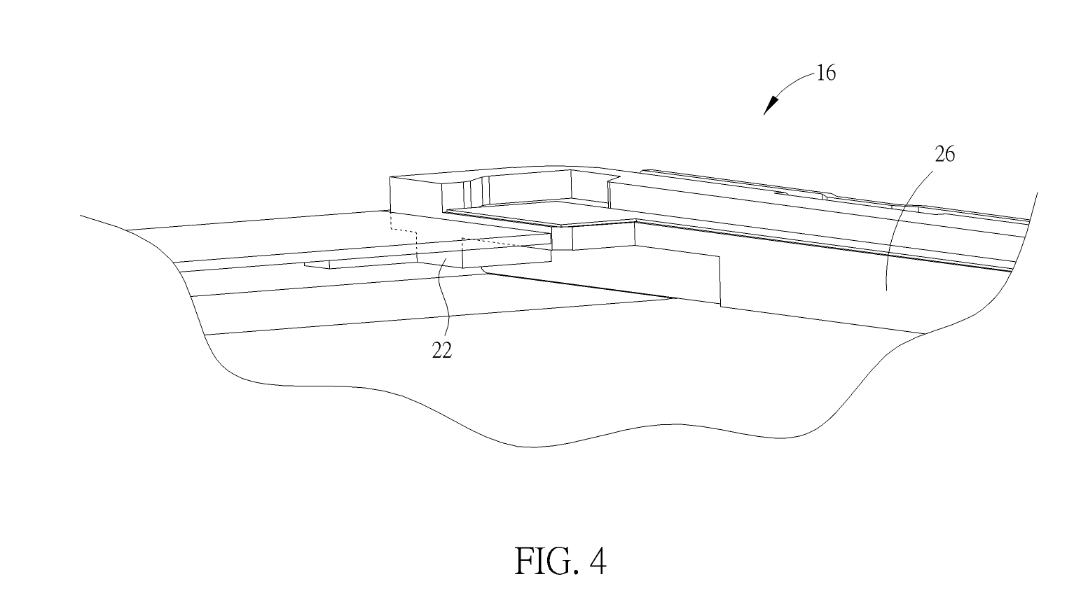

More detailed description for the components of the display apparatus 10 is provided as follows. Please refer to FIG. 2, FIG. 3, and FIG. 4. FIG. 3 is an exploded diagram of the backlight module 14 in FIG. 2. FIG. 4 is a partial enlarged diagram of a bezel 16 in FIG. 3. As shown in FIG. 2 and FIG. 3, the backlight module 14 includes the bezel 16, a light guide plate 18, at least one light emitting diode 20 (one light bar composed of a plurality of light emitting diodes shown in FIG. 3, but not limited thereto), a limiting block 22, and an elastic member 24. The bezel 16 has a containing structure 26. The light guide plate 18 is disposed in the containing structure 26 of the bezel 16 and has a light entrance surface 28 and a side surface 30. The light entrance surface 28 is opposite to the side surface 30. The light emitting diode 20 is disposed at a position corresponding to the light entrance surface 28 of the light guide plate 18 for providing sufficient light to the light guide plate 18 via the light entrance surface 28. Furthermore, as shown in FIG. 2 and FIG. 4, the limiting block 22 is located at a side of the light emitting diode 20 and extends inwardly from the containing structure 26 to abut against the light entrance surface 28 of the light guide plate 18 for constraining movement of the light guide plate 18 toward an −X-axis direction in FIG. 2.

As shown in FIG. 2 and FIG. 3, in this embodiment, the elastic member 24 could be an elastic strip and abut against the side surface 30 of the light guide plate 18 and the containing structure 26. The elastic member 24 is used for providing elastic force to drive the light guide plate 18 to abut against the limiting block 22, so as to position the light guide plate 18 cooperatively with the limiting block 22. The elastic member 24 could be made of rubber material, but not limited thereto, meaning that the elastic member 24 could also be made of other conventional elastic buffer material (e.g. silica gel or foam material). Furthermore, in practical application, as shown in FIG. 3, a plurality of through holes 32 could be formed on the elastic member 24. Accordingly, the plurality of through holes 32 could utilize the characteristic of the hollow structure to provide additional space for deformation of the elastic member 24, so as to further increase elasticity of the elastic member 24.

Via the aforesaid design, if expansion of the light guide plate 18 toward the light emitting diode 20 and the elastic member 24 occurs in a hot environment, the expanded light guide plate 18 could compress the elastic member 24 and then move in an +X-axis direction as shown in FIG. 2. In such a manner, the backlight module 14 could prevent bending deformation of the expanded light guide plate 18. Furthermore, since the limiting block 22 could constrain movement of the expanded light guide plate 18 toward the −X-axis direction in FIG. 2, the optical coupling distance between the light guide plate 18 and the light emitting diode 20 could remain constant. Thus, the present invention could also effectively solve the prior art problem that only a part of light emitted from the light emitting diode could be incident into the light guide plate and the light leakage problem, so as to improve efficiency of the backlight module 14 in use of light.

On the other hand, if inward shrink of the light guide plate 18 occurs in a cold environment, at this time, the elastic force of the elastic member 24 could drive the light guide plate 18 to move in the −X-axis direction in FIG. 2 for abutting against the limiting block 22 since the elastic member 24 abuts against the light guide plate 18 in a compressed state. Accordingly, the optical coupling distance between the light guide plate 18 and the light emitting diode 20 could remain constant, so as to improve efficiency of the backlight module 14 in use of light.

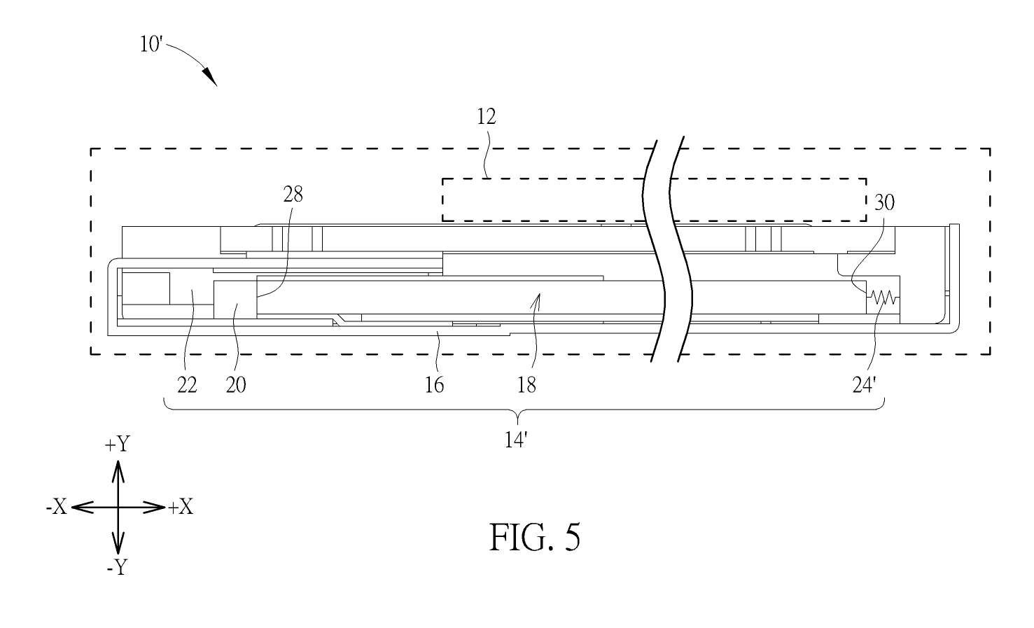

The design of the elastic member is not limited to the aforesaid embodiment. That is, the present invention could also adopt other elastic object, such as a spring, an elastic sheet, or a torsional spring. For example, please refer to FIG. 5, which is a partial sectional diagram of a display apparatus 10′ according to another embodiment of the present invention. Components both mentioned in this embodiment and the aforesaid embodiment represent components with similar functions or structures. In this embodiment, the display apparatus 10′ includes a liquid crystal panel 12 and a backlight module 14′. The backlight module 14′ includes the bezel 16, the light guide plate 18, at least one light emitting diode 20, the limiting block 22, and an elastic member 24′. As shown in FIG. 5, the elastic member 24′ could be a spring. The spring could be connected to the side surface 30 of the light guide plate 18 and the containing structure 26 in a compressed state for providing elastic force to drive the light guide plate 18 to abut against the limiting block 22, so as to position the light guide plate 18 cooperatively with the limiting block 22.

Via the aforesaid design, elasticity of the elastic member 24′ could allow the expanded light guide plate 18 to compress the elastic member 24′ and then to move in the +X-axis direction as shown in FIG. 5, so as to prevent bending deformation of the expanded light guide plate 18. On the other hand, if inward shrink of the light guide plate 18 occurs in a cold environment, the elastic force of the elastic member 24′ could drive the light guide plate 18 to move in the −X-axis direction in FIG. 5 for abutting against the limiting block 22. Accordingly, the optical coupling distance between the light guide plate 18 and the light emitting diode 20 could remain constant.

It should be mentioned that the backlight module of the present invention could have the elastic strip and the spring both disposed thereon or only have the spring connected to the light entrance surface of the light guide plate and the containing structure in a stretched state, so that the design flexibility of the backlight module of the present invention could be further improved. For example, the elastic member could include the elastic strip and the spring. The elastic strip could abut against the side surface of the light guide plate and the containing structure in a compressed state, and the spring could be connected to the side surface of the light guide plate and the containing structure in a compressed state or could be connected to the light entrance surface of the light guide plate and the containing structure in a stretched state. As for the detailed description, it could be reasoned according to the aforesaid embodiment and therefore omitted herein.

Compared with the prior art, the present invention utilizes the elastic force of the elastic member to drive the light guide plate for abutting against the limiting block. Accordingly, even if expansion of the light guide plate occurs in a hot environment or shrink of the light guide plate occurs in a cold environment, the backlight module of the present invention could still make the optical coupling distance between the light guide plate and the light emitting diode remain constant . In such a manner, the present invention could effectively solve the prior art problem that only a part of light emitted from the light emitting diode could be incident into the light guide plate and the light leakage problem, so as to improve efficiency of the backlight module in use of light. Furthermore, since the backlight module of the present invention could only utilize the limiting block and the elastic member to position the light guide plate without glue, the present invention could further simplify the rework process of the backlight module.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight module comprising:
a bezel having a containing structure;
a light guide plate disposed in the containing structure of the bezel and having a side surface and a light entrance surface opposite to the side surface;
at least one light emitting diode disposed at a position corresponding to the light entrance surface of the light guide plate, the at least one light emitting diode being for emitting light into the light guide plate via the light entrance surface;
a limiting block located at a side of the at least one light emitting diode and extending inwardly from the containing structure for abutting against the light entrance surface of the light guide plate; and
an elastic member abutting against at least one of the light entrance surface and the side surface of the light guide plate and the containing structure, the elastic member being for providing elastic force to drive the light entrance surface of the light guide plate to abut against the limiting block, so as to position the light guide plate cooperatively with the limiting block.

2. The backlight module of claim 1, wherein the elastic member is an elastic strip abutting against the side surface of the light guide plate and the containing structure in a compressed state.

3. The backlight module of claim 2, wherein a plurality of through holes is formed on the elastic strip.

4. The backlight module of claim 2, wherein the elastic strip is made of rubber, silica gel, or foam material.

5. The backlight module of claim 1, wherein the elastic member is a spring, and the spring is connected to the side surface of the light guide plate and the containing structure in a compressed state or is connected to the light entrance surface of the light guide plate and the containing structure in a stretched state.

6. The backlight module of claim 1, wherein the elastic member comprises:
an elastic strip abutting against the side surface of the light guide plate and the containing structure in a compressed state; and
a spring connected to the side surface of the light guide plate and the containing structure in a compressed state or connected to the light entrance surface of the light guide plate and the containing structure in a stretched state.

7. The backlight module of claim 6, wherein a plurality of through holes is formed on the elastic strip.

8. The backlight module of claim 6, wherein the elastic strip is made of rubber, silica gel, or foam material.

9. A display apparatus comprising:
a liquid crystal panel; and
a backlight module disposed under the liquid crystal panel for emitting light to the liquid crystal panel, the backlight module comprising:
a bezel having a containing structure;
a light guide plate disposed in the containing structure of the bezel and having a side surface and a light entrance surface opposite to the side surface;
at least one light emitting diode disposed at a position corresponding to the light entrance surface of the light guide plate, the at least one light emitting diode being for emitting light into the light guide plate via the light entrance surface;
a limiting block located at a side of the at least one light emitting diode and extending inwardly from the containing structure for abutting against the light entrance surface of the light guide plate; and
an elastic member abutting against at least one of the light entrance surface and the side surface of the light guide plate and the containing structure, the elastic member being for providing elastic force to drive the light entrance surface of the light guide plate to abut against the limiting block, so as to position the light guide plate cooperatively with the limiting block.

10. The display apparatus of claim 9, wherein the elastic member is an elastic strip abutting against the side surface of the light guide plate and the containing structure in a compressed state.

11. The display apparatus of claim 10, wherein a plurality of through holes is formed on the elastic strip.

12. The display apparatus of claim 10, wherein the elastic strip is made of rubber, silica gel, or foam material.

13. The display apparatus of claim 9, wherein the elastic member is a spring, and the spring is connected to the side surface of the light guide plate and the containing structure in a compressed state or is connected to the light entrance surface of the light guide plate and the containing structure in a stretched state.

14. The display apparatus of claim 1, wherein the elastic member comprises:
an elastic strip abutting against the side surface of the light guide plate and the containing structure in a compressed state; and
a spring connected to the side surface of the light guide plate and the containing structure in a compressed state or connected to the light entrance surface of the light guide plate and the containing structure in a stretched state.

15. The display apparatus of claim 14, wherein a plurality of through holes is formed on the elastic strip.

16. The display apparatus of claim 14, wherein the elastic strip is made of rubber, silica gel, or foam material.
